(19) United States
(12) Patent Application Publication
(10) Pub. No.: US 2009/0327520 A1
(43) Pub. Date: Dec. 31, 2009

(54) METHOD AND APPARATUS FOR MAPPING UNKNOWN INFORMATION IN REAL OR VIRTUAL WORLDS

(76) Inventors: Felix Lee, Portland, OR (US); Chris Kalaboukis, Los Gatos, CA (US)

Correspondence Address: STATTLER - SUH PC, 60 SOUTH MARKET STREET, SUITE 480, SAN JOSE, CA, 95113, US

(21) Appl. No.: 12/146,954

(22) Filed: Jun. 26, 2008

(51) Int. Cl. G06F 15/16

(52) U.S. Cl. 709/240

(57) ABSTRACT

A method and apparatus are given for providing a suggested path on the Internet to a topic of interest for a user. In one example, the method includes receiving the topic of interest, receiving a map of the Internet, receiving a map of information known to the user, calculating a map of information unknown to the user based on the map of the Internet and the map of information known to the user, and calculating a path to the topic of interest based on at least the map of information unknown to the user.

### FIELD OF THE INVENTION

The present invention relates to utilizing maps of the Internet. More particularly, the present invention relates to utilizing maps of unknown information in real or virtual worlds.

### BACKGROUND OF THE INVENTION

A user on the Internet may enter a search query into a search engine. The search engine returns search results to the user. The search results typically are the search engine's guess at things that are similar to the search query. The search engine does not take into consideration whether or not the user knows anything about the query results. The user may in fact know quite a bit about the information returned in the search results. Sometimes, however, the user may desire to venture off into what the user doesn't know.

Unfortunately for a user interested in the unknown, the geometry of the Internet is strongly curved around known territory. In other words, when a user enters a query into a search engine, such as Yahoo!®, the search engine is geared around returning search results of known information related to the query. It is difficult for a user to step outside into unknown territory. The Internet is so huge that haphazardly venturing off into the unknown would likely amount to an exercise in futility.

There is a large difference between the experience of exploring a library and the experience of exploring the Internet. A library has no way of automatically knowing what a user does not know. Accordingly, a library cannot automatically filter out known information for a user. However, even though a typical library does have a large amount of information, the information is organized and searchable in a controlled manner.

The Internet, on the other hand, contains a substantially larger amount of information than a physical library, is constantly changing and does not have a rule set on the organization of information unknown to a particular user. Unfortunately, when a user wants to venture off into the unknown on the Internet, there is currently no mechanism in place to allow the user to explore the unknown efficiently.

### SUMMARY OF THE INVENTION

What is needed is an improved method having features for addressing the problems mentioned above and new features not yet discussed. Broadly speaking, the present invention fills these needs by providing a method and apparatus for mapping unknown information in real or virtual worlds. It should be appreciated that the present invention can be implemented in numerous ways, including as a method, a process, an apparatus, a system or a device. Inventive embodiments of the present invention are summarized below.

In one embodiment, a method is given for providing a suggested path on an Internet to a topic of interest for a user. The method comprises receiving the topic of interest, receiving a map of the Internet, receiving a map of information known to the user, calculating a map of information unknown to the user based on the map of the Internet and the map of information known to the user, and calculating a path to the topic of interest based on at least the map of information unknown to the user.

In another embodiment, a method is given for providing information about where a user may desire to explore next on an Internet. The method comprises receiving a known topic and an acceptable degree of strangeness, receiving a map of the Internet, receiving a map of information known to the user, calculating a map of information unknown to the user based on the map of the Internet and the map of information known to the user, and calculating a suggested next topic based on at least the acceptable degree of strangeness, the map of information unknown to the user and the known topic.

In still another embodiment, an apparatus is given for providing a suggested path on an Internet to a topic of interest for a user. The apparatus comprises a query device configured to receive the topic of interest; a map device configured to receive a map of the Internet, to receive a map of information known to the user, and to calculate a map of information unknown to the user based on the map of the Internet and the map of information known to the user; and a pathfinder device configured to calculate a path to the topic of interest based on at least the map of information unknown to the user.

In yet another embodiment, an apparatus is given for providing information about where a user may desire to explore next on an Internet. The apparatus comprises a query device configured to receive a known topic and an acceptable degree of strangeness; a map device configured to receive a map of the Internet, to receive a map of information known to the user, and to calculate a map of information unknown to the user based on the map of the Internet and the map of information known to the user; and a topic finder device configured to calculate a suggested next topic based on at least the acceptable degree of strangeness, the map of information unknown to the user and the known topic.

In still yet another embodiment, a computer readable medium carrying one or more instructions is given for providing a suggested path on an Internet to a topic of interest for a user. The one or more instructions, when executed by one or more processors, cause the one or more processors to perform the steps of receiving the topic of interest, receiving a map of the Internet, receiving a map of information known to the user, calculating a map of information unknown to the user based on the map of the Internet and the map of information known to the user, and calculating a path to the topic of interest based on at least the map of information unknown to the user.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 is a block diagram of a system for mapping unknown information in real or virtual worlds, in accordance with an embodiment of the present invention;

FIG. 2 is a schematic diagram of a system for providing a suggested path on the Internet to a user's topic of interest, in accordance with an embodiment of the present invention;

FIG. 3 is a schematic diagram of a system for providing information about where the user may desire to explore next on the Internet, in accordance with an embodiment of the present invention;

FIG. 4 is a flowchart of a method for providing a suggested path on the Internet to a user's topic of interest, in accordance with an embodiment of the present invention; and

FIG. 5 is a flowchart of a method for providing information about where the user may desire to explore next on the Internet, in accordance with an embodiment of the present invention.

### DETAILED DESCRIPTION OF THE INVENTION

An invention for a method and apparatus for mapping unknown information in real or virtual worlds is disclosed. Numerous specific details are set forth in order to provide a thorough understanding of the present invention. It will be understood, however, to one skilled in the art, that the present invention may be practiced with other specific details.

### General Overview

This invention presents a system for mapping out information for a user which is specifically unknown to them. The system can present this information in a number of different ways, and can apply to physical mapping of real and virtual worlds, as well as mapping knowledge on pseudo geographic maps.

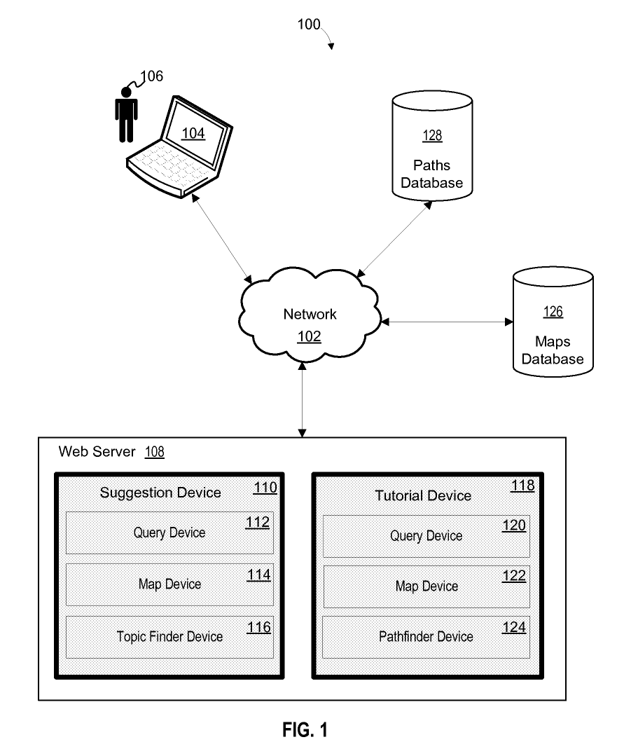

FIG. 1 is a block diagram of a system 100 for mapping unknown information in real or virtual worlds, in accordance with an embodiment of the present invention. A device of the present invention is hardware, software or a combination thereof. A device may sometimes be referred to as an apparatus. Each device is configured to carry out one or more steps of the method of mapping unknown information in real or virtual worlds.

The network 102 couples together a consumer computer 104, a web server 108, a maps database 126 and a paths database 128. The network 102 may be any combination of networks, including without limitation the Internet, a local area network, a wide area network, a wireless network and a cellular network. The consumer computer 104 is configured to be operated by a user 106. The web server 108 includes without limitation a suggestion device 110 and a tutorial device 118. The suggestion device 110 includes without limitation a query device 112, a map device and a topic finder device 116. The tutorial device 118 includes without limitation a query device 120, a map device 122 and a pathfinder device 124. In an alternative embodiment, the consumer computer 104 includes downloaded software (not shown) configured to handle tasks related to gathering information about the user 106.

### Determining What a User Does Not Know

A company like Yahoo!® can map the Internet based on IP (Internet Protocol) addresses of user computers. Yahoo!® gathers enormous amounts of data located at the multitudes of IP (Internet Protocol) addresses. Yahoo!® also gathers information on users. Yahoo!® sees IP addresses from which Yahoo!® can usually infer zip codes and even street-level data. Yahoo!® sees login information and sees the pages that consumers visit. Yahoo!® can infer age, gender, income and other demographic information from analyzing the pages a consumer visits even if the consumer never does a search. Yahoo!® also gathers valuable search data when consumers perform search queries.

Mining a user's past history will build a map of what the user knows or where the user has been. The user's past history includes without limitation information gathered over time from web browsing, email, instant messages, and physical locations. It is assumed that wherever the user has visited and experienced the user knows. Alternatively, there are possible embodiments below which attempt to determine the difference between a fact that the user knows and where they have visited or been. Once a map of what a user knows has been created, it is relatively simple to create an inverse map of what the user does not know. The degrees of knowledge between an unknown item and a known item can be near or far. The system 100 can even use this geographic style of representation to create visual mappings of known/unknown areas of a user's knowledge.

### Visualizing the Unknown

The system 100 involves visualization of aggregated information. The reason “pick a random library shelf” works in a library is that the library is an approximate map of complexity and relevance, with most of the redundancies removed. However, the process of creating that map is labor-intensive and slow. The process does not scale well to Internet size and Internet time. Some combination of the system 100 automating and crowd-sourcing (i.e., aggregation of information from many users) may lead to good visualizations of the complexity and relevance of information.

The system 100 involves utilizing the Internet as a tutor. In other words, the system 100 makes a model of what a user 106 knows and automatically discovers a path (i.e., stepping stones) to something the user doesn't know.

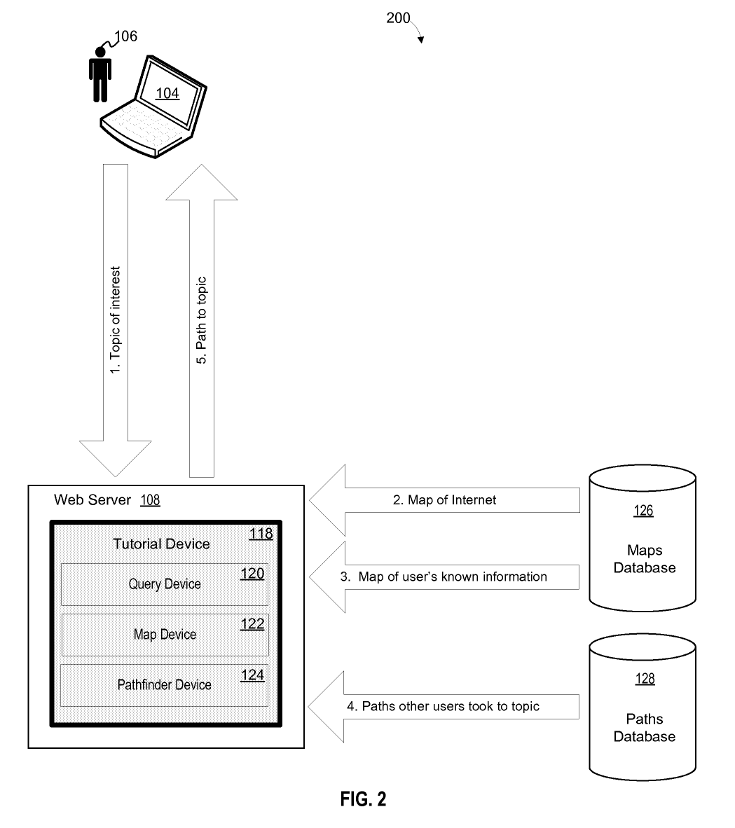

FIG. 2 is a schematic diagram of a system 200 for providing a suggested path on the Internet to a user's topic of interest, in accordance with an embodiment of the present invention. The basic operation is something like this: say the user 106 comes across a paper that looks interesting, but does not really understand it, and would like to understand it. So, the user 106 asks the system 200, “What do I need to know in order to understand this?” In other words, the web server 108 receives from the user computer 104 a topic of interest. Specifically, the query device 120 receives the topic of interest.

The web server 108 has a map of the Internet that the web server 108 receives from the maps database 126. Also, mining a user's past history will build a map of what the user knows or where the user has been. The user's past history includes without limitation information gathered over time from web browsing, email, instant messages, physical locations and any other appropriate sources. This map of the known is stored in the maps database 126. When needed for calculations, the web server 108 retrieves this map of the user's known information from the maps database 126. Based on the map of the Internet and the map of user's known information, the map device 122 then creates an inverse map of what the user 106 does not know. Creation of the inverse map is done by comparing the full Internet corpus against the user's known information and creating a variance between the two.

The web server 108 may also have paths that other users took to the topic of interest. The web server receives these other users' paths from the paths database 128. Based on the inverse map and the other users' paths, the pathfinder device 124 creates a suggested path to the topic of interest. The suggested will tend to be more accurate with as the system 200 can increase the number of user paths that the system 200 aggregates. For example, one path from one other user may not yield a useful suggested path, but thousands of paths aggregated from thousands of other users will likely yield a useful and accurate suggested path for the particular user.

Alternatively, the pathfinder device 124 calculates the suggested path by extrapolation without using the paths that other users took to the topic of interest. In other words, the pathfinder device 124 automatically logically pieces together a path to the topic of interest based on the map of the unknown and the map of the known. To do such logical piecing together, the pathfinder device 124 may use curricula that other people, organizations or entities have built to get to a certain point. For example, there may be a pre-built curriculum, such as a published Internet article, that provides a map of how to learn about the particular topic of interest. Accordingly, the pathfinder device 124 may use a combination of other user paths, pre-built curricula and a map of the unknown in order to calculate a suggested path.

The web server 108 then sends to the user computer 104 the suggested path to the topic of interest (i.e., map of stepping stones of knowledge). The suggested path leads the user 106 from known information to the target piece of knowledge, in other words, to the topic of interest.

Note that the path to the topic of interest does not have to be perfect. The user 106 may mark off the things the user 106 already knows, or may prune the stepping stones of the path that do not look helpful, etc. The important features are the following: the path should give the user 106 a rough idea of how far away the user's goal is and what the user's next steps should be to get to the topic of interest.

Note that without the system 200 a user 106 can still backtrack from the goal, search citations and keywords, etc. What the system 200 adds to existing technology is the ability to tell the user 106 which steps take the user 106 closer or further from the user's goal. That part may solve a jaded audience problem. There's a sweet spot between information that is too familiar and information that too strange. The sweet spot is the territory that people find interesting. The system 200 can model that territory for individuals, and the system 200 has a better chance of showing the user 106 things in that sweet spot.

A producer may also receive a benefit from the system 200. The producer may be able to use inverse maps (i.e., maps of information unknown to users) to find people who are just a step or two away from the producers existing audience. A producer may be, for example, a website publisher or an advertisement publisher.

### Determine Paths Based on Prior Behavior and Others' Behavior

As discussed above with reference to FIG. 2, the pathfinder device 124 creates a suggested path to the topic of interest based on the user's inverse map and other users' paths. Calculations of the pathfinder device 124 may be explained using an analogy to a virtual world. Assume that the user 106 is in the virtual world of World of Warcraft® and that the user 106 does not have a specific goal, other than increasing the level of their character. Steps in World of Warcraft® are a rough analog to learning in the real world. The user 106 needs some help in deciding what to do next or where to go. The user 106 could exit out of the game and search for an online game guide, and get a rough estimate on their next steps. The online game guide gives the user a rough estimate of their potential futures based on some parameters about the user's current location and standing. These game guides may tell the user things like, “If you want X, which is cool, you should do Y and Z,” or “Don't bother trying for W because it's a waste of time”, etc. These game guides are hand-crafted, which is labor-intensive. The quality varies a lot. If the online game changes, it takes some time for game developers to update the game guides.

It's possible programmatically to create such a game guide by having the system 200 automatically discover useful information for user potential futures by observing the behavior of other players in the game who have already gone the same route. For example, if the system 200 tracks player location over time and plots everyone's motion on a map, the system 200 can get a visualization of where the interesting parts of the world are. Such visualization is like a bestseller list; the visualization is not necessarily relevant to the particular user. However, games like World of Warcraft® have easy ways to narrow the scope of that information to “people like me”. The user should be able to limit the guide to players who are the same class and level as the user, perhaps a few levels ahead of the user, etc.

This automation discovery of useful information is another type of crystal ball. No one particular user needs to explicitly create a game guide for anyone. The system 200 automatically creates the game guide by aggregating the behavior of people who are pursuing their own interests. The aggregation is a form of “wisdom of crowds”. The automatic game guide will likely be not as friendly or explicit as a human-created guide. However, the automatic game guide is potentially more reliable and more up-to-date. The contrast between automatic guides versus manual guides is analogous to the contrast between the early hand-maintained web directories and the new world of page-rank search engines.

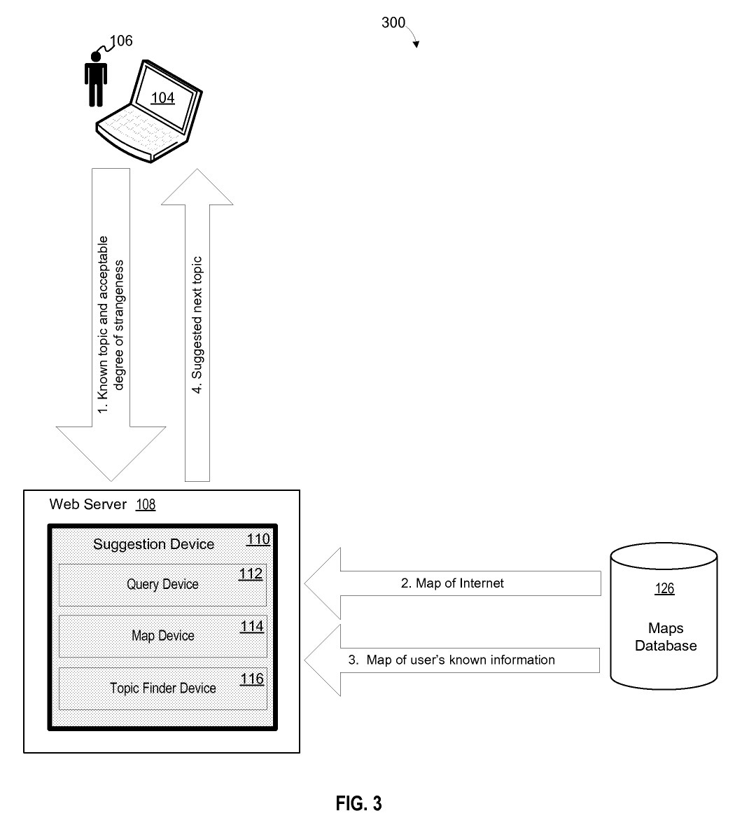

FIG. 3 is a schematic diagram of a system 300 for providing information about where the user may desire to explore next on the Internet, in accordance with an embodiment of the present invention. The system 300 applies the automatic game guide algorithm to the real word. The system 300 uses the algorithm to discover information about where the user 106 may desire to explore next, not necessarily in the sense of physical travel, though physical travel is certainly a possibility. The user 106 may use this technique to explore conceptual landscapes, like discovering new music, or learning more about programming, or whatever.

In order to explore in such a manner, the system 300 needs to know something like the user's World of Warcraft® class/level. In other words, the web server 108 receives from the user computer 104 a known topic specified by the user. Specifically, the query device 112 of the suggestion device 110 receives this known topic. The computer needs to have a model of where the user is now (i.e., a map of what the user knows now) in order to create the map of where the user may go to next. It is also necessary for the suggestion device 110 to know the degree of strangeness to which the user wants to venture from the known topic. The user 106 may want to learn information that is far away from the known topic. On the other hand, the user may not want to venture too far away from the known topic. Accordingly, the query device 112 also receives from the user computer 104 the acceptable degree of strangeness that the user wants to venture from the known topic.

The web server 108 has a map of the Internet that the web server 108 receives from the maps database 126. Also, mining a user's past history will build a map of what the user knows or where the user has been. The user's past history includes without limitation information gathered over time from web browsing, email, instant messages, physical locations and any other appropriate sources. This map of the known is stored in the maps database 126. When needed for calculations, the web server 108 retrieves this map of the user's known information from the maps database 126. Based on the map of the Internet and the map of user's known information, the map device 122 then creates an inverse map of what the user 106 does not know. Based on the inverse map, the topic finder device finds at least one suggested next topic that may be of interest to the user 106. The web server 108 then sends the suggested next topic(s) to the user computer 104.

### Additional Features

The system may operate as an anti-search engine. Search engines mainly discover more detail about things that I know about. With this invention, the system will present things you don't know. So, the system provides an anti-search. The anti-search results are seemingly random but are not totally random because the system intentionally tries to show the user things the user has seen yet.

The system may operate as an anti-popularity engine. Popularity engines mainly discover things about which the dominant culture knows. Anti-popularity engines expressly present the least popular results, which are not necessarily the popular results sorted in reverse order. For example, the question “What are people not listening to in Sunnyvale?” may be a non-trivial problem to solve.

The system may operate as an anti-social graph. Social graphs mainly discover things about which the user's friends know. Anti-social graphs provide things about which the user's friends don't know. The system attempts to present things to the user that their friends don't know.

The system may operate as a filter for a news portal. News portals mainly aggregate things about which average adults are expected to know. Reading the newspaper is like reading the best seller list. The newspaper presents the popular news of the day. However, the user may not want the popular news of the day. Accordingly, the system exposes the relevant parts of an article based on the user's preferences. News articles are previously written. The system auto highlights or auto summarizes these news articles for the user based on stuff that is likely unknown but may be of interested to the user.

The system enhances devices like the Yahoo!® search engine's option of picking a random page. This feature of the search engine typically discovers things that nobody cares about. The system here filters out the uninteresting sites and presents the middle ones. In other words, with the map of the unknown, the system can provide not only random search results but also search results that are unknown and interesting to the user. The system finds what may be interesting to the user by analyzing people who do goal oriented exploration on similar topics of interest. The trial of user exploration is information on connection of knowledge and relevancy. The system can learn through directed exploration, track search behavior and link chains which lead the user to learning. When a user learns something, the system can capture the route that user took to learn that task. People are creating knowledge about relevancy through hyperlinks all the time. The system can capture learning behavior. Aggregated routes create an accurate path to an answer, similar to how ants find food by keep heading out and laying trails. Through automatic categorization and aggregation, the system discovers the similarities of the direction the user is going.

The system may operate as an enhancement to an online service like Wikipedia®. Wikipedia® helps users explore, but there is not specialization. Plus, there is no way for Wikipedia® to show intentionally only stuff the user has not seen before. The system could provide functionality to a service like Wikipedia® that visually represents the known/unknown information.

The system provides an alternative embodiment where a user may download a plug-in to work with the user's browser. The plug-in helps to gather information on the user so the system can construct the map of information known to the user. The plug-in may assist in identifying how long it has been since a user has visited a particular site; the system would consider sites visited a substantially long time ago to be part of the user's map of unknown information. The plug-in may assist in providing a pseudo-geographic map. The plug-in may even assist in helping to provide a map of the internet and visualizing the relationship between the Internet map and the map of known information. Accordingly, the plug-in helps make connections. For example, the plug-in can assist in making connections between all books written in the same town, all books written by authors of the same age, or books that have zebras in them. Most people are not creative enough or do not have the necessary resources to create such connections.

The system may know not only about the user but also about the user's friends. In other words, the system knows what the user knows and what the user's friends know. So, the system also knows information that is of interest to the user and that is unknown to the user's friends. The system then presents such information to the user.

The system may utilize concentric circles of knowledge. For example, an inner circle may be what the user knows; the next bigger circle may be what the user's friends know; and the next bigger circle may be unknown but interesting stuff to the user. The user may decide the user is agnostic about the unknown but interesting stuff. The user may then decide to have the system leave out the stuff that is of no interest to the user.

When a user comes across something the user does not understand, the system envisions and teaches the user the intermediate steps between what the user knows and this thing the user does not understand. These stepping stones can then be used to get other people there. The system becomes more accurate with these stepping stones as more and more people utilize the stepping stones.

The system may improve curricula in school. A teacher typically develops a generalized curriculum for a particular class. However, students come into a class at different levels. For example, one student may need to learn 90% of the information of the class, while another student may need to learn only 25% of the information of the class. The system would allow a teacher to customize a curriculum for each individual student because the system can build a map of the unknown for each individual student.

### Method Outline

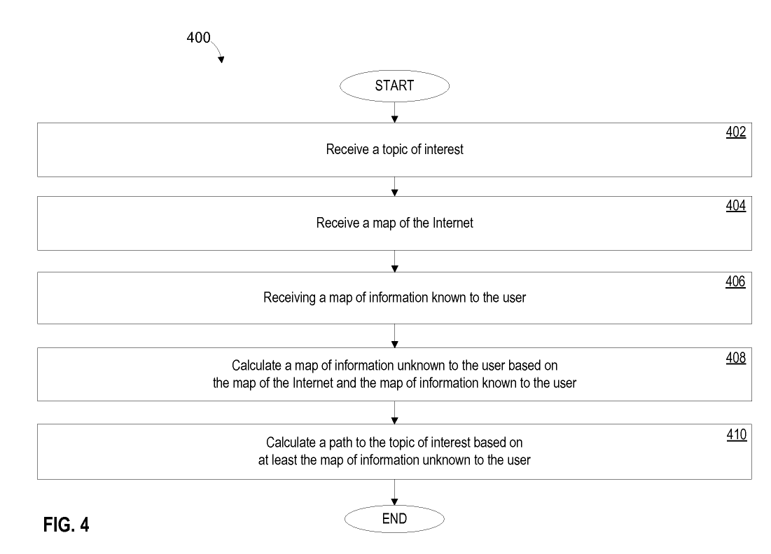

FIG. 4 is a flowchart of a method 400 for providing a suggested path on the Internet to a user's topic of interest, in accordance with an embodiment of the present invention. The method 400 starts in step 402 where the system receives, typically from a user computer, a topic of interest. The query device 120 of FIG. 2 may be configured to carry out this step 402. The method 400 then moves to step 404 where the system receives a map of the Internet. This map of the Internet is pre-built and is received from a database. The map device 122 of FIG. 2 may be configured to carry out this step 404. Next, in step 406, the system receives a map of information known to the user. This map may be built during run-time or may be pre-built and received from a database. The map device 122 of FIG. 2 may be configured to carry out this step 406. Then, in step 408, the system calculates a map of information unknown to the user based on the map of the Internet and the map of information known to the user. The system basically subtracts the map of known information from the map of the Internet in order to calculate the map of unknown information. The map device 122 of FIG. 2 may be configured to carry out this step 408. The method then proceeds to step 410 where the system calculates a path to the topic of interest based on at least the map of information unknown to the user. Other factors that the system may consider in this calculation include without limitation paths other users took to the topic of interest and pre-built curricula for the topic of interest. The pathfinder device 124 of FIG. 2 may be configured to carry out this step 410. The method 400 is then at an end.

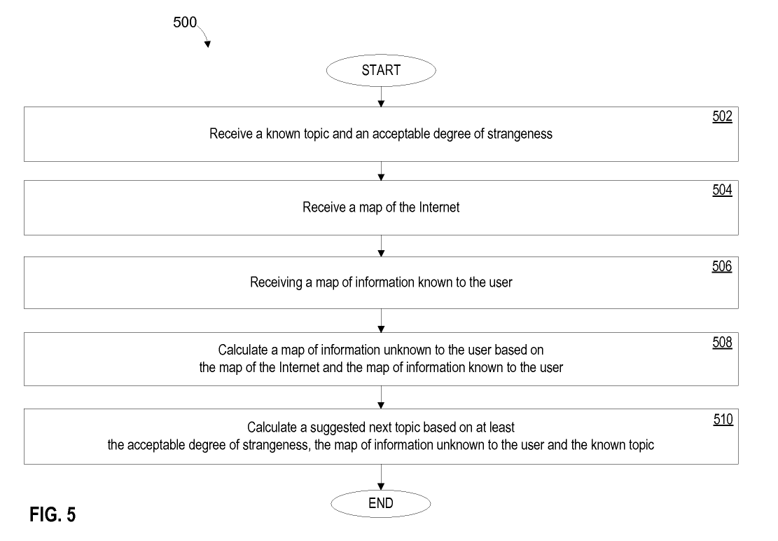

FIG. 5 is a flowchart of a method 500 for providing information about where the user may desire to explore next on the Internet, in accordance with an embodiment of the present invention. The method 500 starts in step 502 where the system receives, typically from a user computer, a known topic and an acceptable degree of strangeness. The acceptable degree of strangeness is some indication of how esoteric the user would like to venture away from the known topic. The query device 112 of FIG. 3 may be configured to carry out this step 502. The method 500 then moves to step 504 where the system receives a map of the Internet. This map is pre-built and is received from a database. The map device 114 of FIG. 3 may be configured to carry out this step 504. Next, in step 506, the system receives a map of information known to the user. This map may be built during run-time or may be pre-built and received from a database. The map device 114 of FIG. 3 may be configured to carry out this step 506. Then, in step 508, the system calculates a map of information unknown to the user based on the map of the Internet and the map of information known to the user. The system basically subtracts the map of known information from the map of the Internet in order to calculate the map of the unknown information. The map device 114 of FIG. 3 may be configured to carry out this step 508. The method then proceeds to step 510 where the system calculates a suggested next topic based on at least the acceptable degree of strangeness, the map of information unknown to the user and the known topic. The topic finder device 116 of FIG. 3 may be configured to carry out this step 510. The method 500 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation receiving the topic of interest, receiving a map of the Internet, receiving a map of information known to the user, calculating a map of information unknown to the user based on the map of the Internet and the map of information known to the user, and calculating a path to the topic of interest based on at least the map of information unknown to the user, according to processes of the present invention.

### ADVANTAGES

The system of the present invention provides an automated ability to guide a user to a goal set of knowledge. The system provides the ability to determine a broader audience for producers. Expanding an audience for a producer, such as an advertiser or website publisher, may result in additional user inventory for the producer and for the system. Automated guides that the system calculates can provide teaching mechanisms that can build training programs or curricula custom tailored for each individual student.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of providing a suggested path on an Internet to a topic of interest for a user, the method comprising:
receiving the topic of interest;
receiving a map of the Internet;
receiving a map of information known to the user;
calculating a map of information unknown to the user based on the map of the Internet and the map of information known to the user; and
calculating a path to the topic of interest based on at least the map of information unknown to the user.

2. The method of claim 1, wherein calculating the map of information unknown to the user comprises subtracting the map of known information from the map of the Internet.

3. The method of claim 1, wherein receiving a map of information known to the user comprises building the map of information known to the user by mining past history of the user, where past history of the user includes information gather over time from at least one of:
web browsing history;
email;
instant messages;
physical locations; and
any other appropriate sources.

4. The method of claim 1, wherein the calculating the path to the topic of interest is further based on at least one of:
paths other users took to the topic of interest;
pre-built curricula for the topic of interest; and
logically piecing together a path to the topic of interest based on the map of the unknown and the map of the known.

5. The method of claim 1, wherein calculating the path to the topic of interest comprises providing a rough idea of how far away the user is from the topic of interest and what should be next steps of the user.

6. A method of providing information about where a user may desire to explore next on an Internet, the method comprising:
receiving a known topic and an acceptable degree of strangeness;
receiving a map of the Internet;
receiving a map of information known to the user;
calculating a map of information unknown to the user based on the map of the Internet and the map of information known to the user; and
calculating a suggested next topic based on at least the acceptable degree of strangeness, the map of information unknown to the user and the known topic.

7. The method of claim 6, wherein calculating the map of information unknown to the user comprises subtracting the map of known information from the map of the Internet.

8. The method of claim 6, wherein receiving a map of information known to the user comprises building the map of information known to the user by mining past history of the user, wherein the past history of the user includes information gathered over time from at least one of:
web browsing history;
email;
instant messages;
physical locations; and
any other appropriate sources.

9. The method of claim 6, wherein calculating a suggested next topic is further based on a graph of information unknown to friends of the user.

10. The method of claim 6, wherein calculating a suggested next topic comprises highlighting unknown parts of a published article on the Internet.

11. An apparatus for providing a suggested path on an Internet to a topic of interest for a user, the apparatus comprising:
a query device configured to receive the topic of interest;
a map device configured to receive a map of the Internet, to receive a map of information known to the user, and to calculate a map of information unknown to the user based on the map of the Internet and the map of information known to the user; and
a pathfinder device configured to calculate a path to the topic of interest based on at least the map of information unknown to the user.

12. The apparatus of claim 11, wherein the map device is further configured to calculate the map of information unknown to the user by subtracting the map of known information from the map of the Internet.

13. The apparatus of claim 11, wherein the map device is further configured to build the map of information known to the user by mining past history of the user, where past history of the user includes information gather over time from at least one of:
web browsing history;
email;
instant messages;
physical locations; and
any other appropriate sources.

14. The apparatus of claim 11, wherein the pathfinder device is further configured to calculate the path to the topic of interest based further on at least one of:
paths other users took to the topic of interest;
pre-built curricula for the topic of interest; and
logically piecing together a path to the topic of interest based on the map of the unknown and the map of the known.

15. The apparatus of claim 11, wherein the pathfinder device is further configured to provide a rough idea of how far away the user is from the topic of interest and what should be next steps of the user.

16. An apparatus for providing information about where a user may desire to explore next on an Internet, the apparatus comprising:
a query device configured to receive a known topic and an acceptable degree of strangeness;
a map device configured to receive a map of the Internet, to receive a map of information known to the user, and to calculate a map of information unknown to the user based on the map of the Internet and the map of information known to the user; and
a topic finder device configured to calculate a suggested next topic based on at least the acceptable degree of strangeness, the map of information unknown to the user and the known topic.

17. The apparatus of claim 16, wherein the map device is further configured to calculate the map of information unknown to the user by subtracting the map of known information from the map of the Internet.

18. The apparatus of claim 16, wherein the map device is further configured to build the map of information known to the user by mining past history of the user, wherein the past history of the user includes information gathered over time from at least one of:
web browsing history;
email;
instant messages;
physical locations; and
any other appropriate sources.

19. The apparatus of claim 16, wherein the topic finder device is further configured to calculate a suggested next topic based further on a graph of information unknown to friends of the user.

20. The apparatus of claim 16, wherein the topic finder device is further configured to highlight unknown parts of a published article on the Internet.

21. A computer readable medium carrying one or more instructions for providing a suggested path on an Internet to a topic of interest for a user, wherein the one or more instructions, when executed by one or more processors, cause the one or more processors to perform the steps of:
receiving the topic of interest;
receiving a map of the Internet;
receiving a map of information known to the user;
calculating a map of information unknown to the user based on the map of the Internet and the map of information known to the user; and
calculating a path to the topic of interest based on at least the map of information unknown to the user.
